(19) United States
(12) Patent Application Publication
(10) Pub. No.: US 2008/0075869 A1
(43) Pub. Date: Mar. 27, 2008

(54) MULTI-FUNCTIONAL PAPER FOR ENHANCED PRINTING PERFORMANCE

(75) Inventor: Leo M. Nelli, Piscataway, NJ (US)

Correspondence Address: MICHAEL BEST & FRIEDRICH LLP, 100 E WISCONSIN AVENUE, Suite 3300, MILWAUKEE, WI, 53202, US

(73) Assignee: DEGUSSA CORPORATION, Parsippany, NJ (US)

(21) Appl. No.: 11/693,942

(22) Filed: Mar. 30, 2007

Related U.S. Application Data
(60) Provisional application No. 60/847,358, filed on Sep. 26, 2006.

(51) Int. Cl. B05D 3/00

(52) U.S. Cl. 427/387; 428/142

(57) ABSTRACT

Coated substrates include a substrate coated with a coating composition comprising a metal oxide, a binder and optionally a mordant and a crosslinker for the binder. The substrate may be paper, such as commodity paper, and the metal oxide may be a fumed metal oxide or a colloidal metal oxide. The coating may be non-glossy and may be applied at a low coat weight. Methods for making coated substrates are also disclosed. The coating may be applied to the substrate during manufacture of the substrate, for example the coating may be applied to paper using a size-press machine during its manufacture.

### CROSS-REFERENCE TO RELATED APPLICATIONS

This application claims priority to U.S. Provisional Patent Application Ser. No. 60/847,358, filed on Sep. 26, 2006, the entire contents of which are hereby incorporated by reference.

### BACKGROUND

Substrates having characteristics that make them receptive to receiving printed images are desirable.

### SUMMARY

In one aspect, a coated substrate comprising a substrate coated with a coating which includes a metal oxide present at a coat weight of less than about 0.8 g coating/m² is provided.

In another aspect, a coated substrate comprising a substrate coated with a coating which includes a metal oxide, the coating having a specular gloss of less than about 15% at 60° is provided.

In a further aspect, a recording medium comprising a coated substrate with one or more images printed thereon is also provided.

In another aspect, a method of producing a coated paper having a specular gloss of less than about 15% at 60°, by applying a coating composition comprising a metal oxide to the paper is provided. The coated paper may be suitably applied at a coat weight of less than about 5 g coating/m² paper and using a size press.

### DETAILED DESCRIPTION

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,”

“including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any nonclaimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

It also is understood that any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between the lowest value and the highest value enumerated are to be considered to be expressly stated in this application.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximation, the numerical values set forth in the specific examples are reported as precisely as possible. Any numerical value, however, inherently contain certain errors necessarily resulting from the standard deviation found in their respective testing measurements.

In one aspect, the invention provides a substrate coated with a coating composition comprising a metal oxide, a binder and optionally a mordant and a crosslinker for the binder. The substrate may be paper, such as a commodity paper. The coating composition may contain fumed or colloidal metal oxides, such as fumed silica, colloidal silica, fumed alumina or a combination thereof, a binder such as polyvinylalcohol, and, optionally, a mordant such as polyDADMAC and a crosslinker for the binder such as glyoxyl. The substrate may be coated such that the coat weight is less than about 5 g, less than about 2 g, less than about 1 g, less than about 0.8 g, less than about 0.5 g or less than about 0.1 g coating composition per m² substrate. The substrate may be coated such that there is less than about 4 g, less than about 1 g, less than about 0.5 g, less than about 0.2 g, less than about 0.1 g, or less than about 0.05 g metal oxide per m² substrate. The coated substrate may be non-glossy, having, for example, a specular gloss of less than about 10% at 60°.

In another aspect, the invention provides a substrate coated with a coating composition comprising a metal oxide, more particularly, a fumed metal oxide, colloidal metal oxide, or a combination thereof. Metal oxides according to the invention include, but are not limited to, silicon dioxide, aluminium oxide, titanium dioxide, cerium oxide, zirconium oxide, or a combination thereof. There is no restriction on the source of the metal and non-metal oxides. For example, metal oxides produced by flame hydrolysis, such as silicon dioxide and aluminium oxide, may be suitably used. The metal oxide may comprise at least one of fumed silica particles, fumed alumina particles, and combinations thereof. The composition may further comprise a dispersing medium for the particles, such as water, a binder or a combination thereof. The composition may be used to coat a substrate to enhance the printing characteristics of the substrate. Examples of printing may include, but are not limited to, ink-jet printing, laser printing, copier printing, high-speed digital printing, printers using liquid toners, rotogravure printing, flexographic printing, lithographic printing and thermal printers. Suitable thermal printers may be used to print variable information, such as bar codes, may be color or monochrome, and may use solid or phase change inks. The thermal insulating properties of the metal oxide in the coatings of the invention may result in thermal printer inks drying quickly.

Fumed silica particles can be produced by pyrogenic processes and have the chemical composition SiO₂. Fumed silica particles, typically, are aggregate particles of smaller primary particles, which are held together by relatively strong cohesive forces, such that the aggregate particles do not break down into primary particles when dispersed in a liquid medium. Aggregate fumed silica particles may also form larger agglomerate particles, which are held together by relatively weak cohesive forces. Agglomerate particles may be broken down into aggregate particles when dispersed in a liquid medium. Suitable silica particles for use in the present invention have a sub-micron particle size. For example, suitable silica particles may have an aggregate particle size of at least about 5, and more particularly, at least about 25, at least about 50, at least about 65, at least about 80, at least about 90 or at least about 95 nm. The aggregate particle size is generally less than about 400, and more particularly, less than about 350, less than about 300, less than about 275, less than about 250, less than about 200, less than about 150, or less than about 125 nm.

The coating compositions may comprise fumed metal oxides or dispersions comprising the same. Commercially available fumed silicas suitable for use in the invention include, but are not limited to, those sold under the trademark AERODISP® (Degussa). Suitably, the fumed metal oxide in the dispersion may be doped with a different fumed metal oxide, for example fumed silica doped with fumed alumina. Suitable dispersions include, but are not limited to, AERODISP® WK 341 (a cationized silica dispersion), VP Disp WK 7330 (a cationized fumed mixed metal oxide dispersion—fumed silica doped with fumed alumina), AERODISP® WK 7520, AERODISP® G 1220, AERODISP® W1450, AERODISP® W7215S, AERODISP®V W 1226, AERODISP® W 1714, AERODISP® W 1824, AERODISP® W 1836, AERODISP® W 630, AERODISP® W440, VP DISP W7330N, VP DISP W740X, VP DISP 2730, VP DISP 2550, AERODISP® W 7215 S, AERODISP® W 7512 S, AERODISP® W 7520, AERODISP® W 7520 N, AERODISP® W7520P, AERODISP® W 7622, AERODISP® WK 341, and VP DISP W340; those commercially available from Cabot Corporation, such as CAB-SPERSE® PG 022, CAB-O-SPERSE® A 2012, CAB-O-SPERSE® 2012A, CAB-SPERSE® 2020K, CAB-SPERSE® A 2017, CAB-O-SPERSE® 2017A, CAB-SPERSE® 1030K, CAB-O-SPERSE® K 2020, CAB-O-SPERSE® 2020K, CAB-O-SPERSE® 4012K, CAB-O-SPERSE® PG 002CAB-O-SPERSE® PG 001, CAB-O-SPERSE® 1015A, CAB-O-SPERSE®t 1020K, CAB-O-SPERSE® GP 32/12, CAB-O-SPERSE® GP 32/17, CAB-O-SPERSE® GP 50, CAB-O-SPERSE® MT 32/17, CAB-O-SPERSE® A 105, CAB-O-SPERSE® A 1095, CAB-O-SPERSE® A 205, CAB-O-SPERSE® A 1695, CAB-O-SPERSE® A 2095, CAB-O-SPERSE® C 1030K, CAB-O-SPERSE® C1015A, CAB-O-SPERSE® K 4012, CAB-O-SPERSE® P 1010, CAB-O-SPERSE® II, CAB-O-SPERSE® A 3875, CAB-O-SPERSE® PG 001, CAB-O-SPERSE® PG 002 and CAB-O-SPERSE® CT 302C; and those commercially available from Wacker Chemie AG, such as, HDK® XK20030, HDK® A2012, HDK® 1515B, HDK®B 2012B, HDK® A3017 and HDK® A3017B; and combinations thereof.

Suitable metal oxides and dispersions comprising the same are disclosed in United States Patent Application Publication Nos. US2006154994, US20040106697, US2003095905, US2002041952, International Publication Nos. WO2006067131, WO2006067127, WO2005061385, WO2004050377, WO9722670, Canadian Application No. CA2285792, and U.S. Pat. Nos. 7,015,270, 6,808,769, 6,840,992, 6,680,109 and 5,827,363, each of which is hereby fully incorporated by reference.

Other suitable metal oxides and dispersions comprising the same include, but are not limited to, those commercially available from Akzo Nobel/EKA Chemicals, such as BINDZIL® 15/500, BINDZIL® 30/360, BINDZIL® 30/220, BINDZIL® 305, BINDZIL® 30NH2/220, BINDZIL® 40/220, BINDZIL® 40/170, BINDZIL® 30/80, BINDZIL® CAT 80, BINDZIL® F 45, BINDZIL® 50/80, NYACOL® 215, NYACOL® 830, NYACOL® 1430, NYACOL® 1440, NYACOL® 2034DI, NYACOL® 2040, NYACOL® 2040NH4 and NYACOL® 9950; those commercially available from H. C. Stark/Bayer, such as LEVASIL® 500/15%, LEVASIL® 300/30%, LEVASIL® 300F/30%, LEVASIL® 200E/20%, LEVASIL® 200S/30%, LEVASIL® 200A/30%, LEVASIL® 200/30%, LEVASIL® 200N/30%, LEVASIL® 200/40%, LEVASIL® 100/45%, LEVASIL® 100S/30%, LEVASIL® 100/30%, LEVASIL® 50 CK 30, LEVASIL® 4063, LEVASIL® 100S/45%, LEVASIL® 50/50%; those commercially available from Grace Davison, such as LUDOX® SM, LUDOX® HS-30, LUDOX® LS, LUDOX® HS-40, LUDOX® AM, LUDOX® WP, LUDOX® AS, LUDOX® TM; those commercially available from Nalco Chemical, such as NALCO® 1115, NALCO® 2326, NALCO® 6011, NALCO® 1130, NALCO® 1030, NALCO® 6010, NALCO® 1140, NALCO® 2325, NALCO® 2327, NALCO® 1060, NALCO® 1034, NALCO® 1129, NALCO® 1050, NALCO® 6009; those commercially available from Nissan Chemical Industries Ltd., such as SNOWTEX® 20, SNOWTEX® 30, SNOWTEX® C, SNOWTEX® N, SNOWTEX® 0; and those commercially available from Clariant/Rodel, such as KLEBOSOL® 30N25, KLEBOSOL® 30H25, KLEBOSOL® 30N50PHN, KLEBOSOL®B 30N50, KLEBOSOL® 30H50, KLEBOSOL® 1501-50, KLEBOSOL® 1508-50, KLEBOSOL® 1498-50. The coating compositions of the invention may comprise any of these metal oxides, dispersions comprising metal oxides or combinations thereof.

The surface area of most metal oxide particles can be determined by the method of S. Brunauer, P. H. Emmet, and I. Teller, J. Am. Chemical Society, 60, 309 (1938), which is commonly referred to as the BET method. Fumed silica particles suitable for use in the invention may have a BET surface area of at least about 30 m²/g, at least about 50 m²/g, or at least about 70 m²/g. The surface area is suitably less than about 400 m²/g, less than about 350 or less than about 325 m²/g. In some embodiments, the fumed silica particles have a BET surface area of about 90 m²/g, about 200 m²/g or about 300 m²/g.

In one embodiment, the metal oxide is present in an aqueous dispersion before being combined with a binder to form a composition and/or applied to the substrate. The aqueous dispersion may comprise distilled or deionized water. The composition also may comprise any number of suitable water-miscible liquids, such as one or more water-miscible alcohols (e.g., methanol, ethanol, etc.) or ketones (e.g., acetone) in addition to water. A suitable coating composition contains at least one binder and an aqueous dispersion comprising fumed silica particles.

As used herein, the term “binder” refers to a compound that helps facilitate adherence of the metal oxide particles to the substrate. Any suitable binder(s) can be used in compositions of the invention including water swellable polymers having a hydrophilic functional group such as a hydroxyl and/or amine. Suitably, the binder comprises at least one of cellulose derivatives (e.g. hydroxyethyl cellulose, carboxymethyl cellulose, cellulose esters, cellulose ethers), casein, gelatin, protein, starch (e.g. oxidized, esterified, or other modified types of starch), vinyl polymers (e.g. polyvinyl alcohol, polyvinyl pyrrolidine, polyvinyl acetate, styrene butadiene and derivatives), acrylic polymers (e.g. polymethyl methacrylate, lattices of acrylic polymers, such as acrylate esters, styrene-acrylic esters), polyesters, polycarbonate polymers, polyamides, polyimides, epoxy polymers, phenolic polymers, polyolefins, polyurethanes copolymers thereof, and mixtures thereof.

In one embodiment, the binder may be polyvinyl alcohol, partially or entirely saponified, or cationized polyvinyl alcohol with a primary, secondary or tertiary amino group or a tertiary ammonium group on the main chain or on the side chain. Combinations of these polyvinyl alcohols with one another and polyvinyl pyrrolidones, polyvinyl acetates, silanized polyvinyl alcohols, styrene-acrylate latices, styrene-butadiene latices, melamine resins, ethylene-vinyl acetate copolymers, polyurethane resins, synthetic resins such as polymethyl methacrylates, polyester resins (for example unsaturated polyester resins), polyacrylates, modified starch, casein, gelatine and/or cellulose derivates (for example carboxymethyl cellulose) may also be used. Polyvinyl alcohol or cationized polyvinyl alcohol can suitably be used.

A suitable amount of binder in the composition depends on the particular binder and upon the type or surface area of the metal oxide, such as silica, that is used. For example, the optimum amount of polyvinyl alcohol in the composition for a particular application may be different from the optimum amount of polyvinyl pyrrolidine in the composition for that application. The optimum amount of binder may also vary with the surface area of the metal oxide or combination of metal oxides.

The ratio of metal oxide to binder in the composition may also be varied depending upon the application and the desired result. Suitably, the ratio of metal oxide to binder is at least about 0.25:1, at least about 1:1, at least about 1.5:1, at least about 2:1, at least about 2.5:1, or at least about 3:1. The ratio of silica and binder is typically less than about 100:1, less than about 50:1, less than about 25:1, less than about 20:1, less than about 15:1, less than about 12:1, or less than about 10:1. Suitable pigment to binder ratios improve adhesion of the particles to the paper to avoid a loss of the particles from the surface and reduce premature knife wear when the paper is cut to form sheets.

Generally, the coating compositions of the invention may have a viscosity ranging from very low to very high, provided they are capable of being deposited on to the surface of the substrate using techniques known in the art. Any suitable technique known in the art may be used to measure the viscosity of the compositions. For example, viscosity may be measured using a Brookfield LVT viscometer. Suitably, the viscosity may be at least about 1, at least about 5, at least about 10, at least about 15, at least about 20, or at least about 50 centipoise. The viscosity may be less than about 1,000, less than about 500, less than about 350, less than about 200 or less than about 150 centipoise. If a size press is used to apply the coating, a suitable viscosity may be from about 20 centipoise to about 200 centipoise. The size press may also be modified, for example by adding a rod or blade attachment, and a suitable viscosity may be from about 20 centipoise to about 500 centipoise. Smaller metal oxide particles of, for example, less than 100 nm, may be suitably in a coating having a viscosity of from about 20 centipoise to about 500 centipoise.

The coating composition can be prepared using a variety of methods. In one embodiment, the composition is prepared by combining an aqueous dispersion (e.g., an aqueous dispersion comprising fumed silica particles and water) with at least one binder to produce the coating composition. The dispersion and the binder may be combined, for example, by mixing with a high-shear mixer. The pH of the coating composition can be adjusted at any stage during its preparation to a desired pH. However, in some embodiments no adjustment of the pH is required. In one embodiment, the pH is directly adjusted on the dispersion when accompanied by high shear mixing. The pH also may be adjusted after the dispersion is mixed with the binder (i.e., after forming the coating composition). An adjustment in pH will usually be accompanied by a rise in viscosity as the dispersion approaches the neutral pH range (6.5-7.5). The pH can be adjusted using any suitable method, such as via the addition of an acid (e.g., mineral acid, acidic cation exchange resin, etc.) or a base (e.g., an alkali metal hydroxide, basic anion exchange resin, etc.). The coating compositions may be acidic or alkaline. Suitably, the pH of the coating compositions may fall within a pH range of about 2.5 to about 10.5; for example a pH range of about 2 to about 6 or about 8 to about 10.5.

The coating composition also can further comprise one or more other additives, such as surfactants (e.g., cationic surfactants, anionic surfactants such as long-chain alkylbenzene sulfonate salts and long-chain, suitably branched-chain, alkylsulfosuccinate esters, nonionic surfactants such as polyalkylene oxide ethers of long-chain, preferably branched-chain alkyl group-containing phenols and polyalkylene oxide ethers of long-chain alkyl alcohols, and fluorinated surfactants), hardeners (e.g., active halogen compounds, vinylsulfone compounds, aziridine compounds, epoxy compounds, acryloyl compounds, isocyanate compounds, etc.), thickeners (e.g., carboxymethyl cellulose (CMC)), flowability improvers, antifoamers (e.g., octyl alcohol, silicone-based antifoamers, etc.), foam inhibitors, releasing agents, foaming agents, penetrants, colorants (e.g. dyes or pigments), pigment dispersants, optical brighteners, whiteners (e.g., fluorescent whiteners), preservatives (e.g., p-hydroxybenzoate ester compounds, benzisothiazolone compounds, isothiazolone compounds, etc.), biocides, antifungal agents, yellowing inhibitors (e.g., sodium hydroxymethanesulfonate, sodium p-toluenesulfinate, etc.), ultraviolet absorbers (e.g., benzotriazole compounds having an hydroxy-dialkylphenyl group at the 2-position), antioxidants (e.g., sterically hindered phenol compounds), antistatic agents, pH regulators (e.g., sodium hydroxide, sodium carbonate, sulfuric acid, hydrochloric acid, phosphoric acid, citric acid, etc.), water-resisting agents, wet strengthening agents, dry strengthening agents and lubricants (polyethylene waxes, natural waxes such as carnauba wax, calcium stearate, fatty acids and salts of fatty acids, paraffin). Crosslinking agents such as zirconium oxides, boric acid, melamine resins, glyoxal and isocyanates and other molecules which link together the molecule chains of the binder system also can be used in the invention. These crosslinking agents may increase the water resistance of the binder system and hence of the coating.

The coating composition also may comprise a mordant, such as a cationic polymer, which may enhance the water-fastness of the composition. Cationic polymers include polymers having at least one quaternary ammonium group, phosphonium group, an acid adduct of a primary, secondary or tertiary amine group, polyethylene imines, polydiallyl amines or polyallyl amines, polyvinyl amines, dicyandiamide condensates, dicyandiamide-polyamine cocondensates or polyamide-formaldehyde condensates. The cationic quaternary (NH₄⁺) functionality of many polymers and salts may facilitate the binding of anionic dyes commonly used in ink jet inks. Suitable mordants include, but are not limited to, poly(vinylbenzyl trimethylammonium chloride), polyamines, polyethyleneimine (PEI), poly (diallyl dimethyl ammonium chloride (polyDADMAC), or poly(diallyl dimethyl ammonium chloride) solution (polyDADMAC solution in water) and mixtures thereof.

Those mordants deriving from a diallyl ammonium compound can suitably be used, particularly those deriving from a dialkyl diallyl compound, which can be obtained by a radical cyclisation reaction of diallyl amine compounds and display the structure 1 or 2. Structures 3 and 4 represent copolymers deriving from dialkyl diallyl compounds. R₁ and R₂ represent a hydrogen atom, an alkyl group having 1 to 4 C atoms, methyl, an ethyl, an n-propyl, an iso-propyl, an n-butyl, an iso-butyl or a tert.-butyl group, whereby R₁ and R₂ can be the same or different. A hydrogen atom from the alkyl group can also be substituted by a hydroxyl group. Y represents a radical-polymerisable monomer unit, such as e.g. sulfonyl, acrylamide, methacrylamide, acrylic acid, methacrylic acid. X⁻ represents an anion.

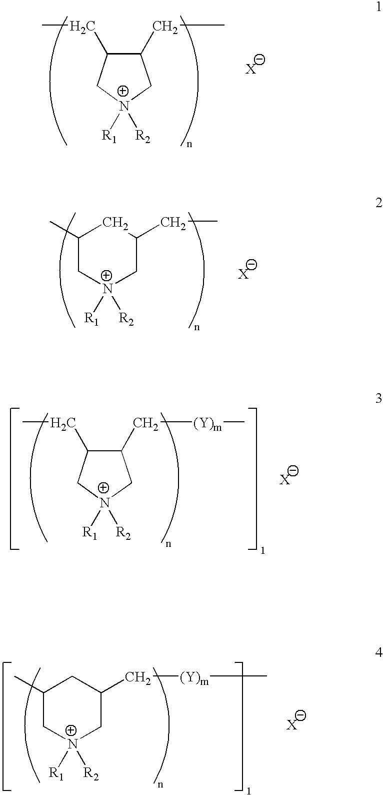

Additionally, colorants such as pigments or dyes may be added to the coating composition. These pigments or dyes may enhance the whiteness or color of the compositions when applied to a substrate. Suitable pigments include clay (standard grades, calcined grades, delaminated grades, chemically structured grades, composites/specialty grades), titanium dioxide (rutile, anatase), calcium carbonate (ground, precipitated), alumina tri-hydrate, sodium silicates, phyllosilicates, aluminium silicates, plastics pigments (for example polystyrene, polyethylene, polypropylene), silicas (for example colloidal silicas, precipitated silicas, silica gels, cationised modifications of the cited silica compounds, aluminium compounds (for example aluminium sols, colloidal aluminium oxides and hydroxyl compounds thereof, such as pseudoboehmites, boehmites, aluminium hydroxide), magnesium oxide, zinc oxide, zirconium oxide, magnesium carbonates, kaolin, clay, talc, calcium sulfate, zinc carbonate, satin white, lithopones, zeolites. Calcium carbonate, alumina tri-hydrate and sodium silicates may also enhance the ink jet performance of the composition when coated onto a substrate. The presence of silica in the composition, such as fumed silica, may advantageously reduce the amount of agglomeration of these additional pigments.

The invention further provides a recording medium comprising a substrate coated with the coating composition as described herein applied to at least a portion of the substrate. As used herein, a “coated paper,” “coated substrate” or “coated recording medium” is one that has been coated with a coating composition as set forth herein. The substrate is suitably a paper compatible with a printing device. As used herein, the term “paper” includes, but is not limited to, paper, paperboard and cardboard. Suitable papers include commodity papers. As used herein a “commodity paper” is paper, having a weight of 35 to 400 g/m², and, if white, a GE brightness of at least about 84%, at least about 86%, at least about 88% or at least about 90% and less than about 100%, less than about 99%, less than about 98%, less than about 97% or less than about 96%. Brightness is a measure of the amount of light reflected off the surface of the paper. A commodity paper, as used herein, has a Hercules Size Test (HST) value, which is a measure of how well the paper repels water, of at least about 0, at least about 5, at least about 10, at least about 20, at least about 30, at least about 40, or at least about 50 sec and less than about 500, less than about 400, less than about 300, less than about 250, or less than about 200 sec. A commodity paper, as used herein, specifically excludes glossy, photo-quality and laminated papers. Typical inexpensive commercially available commodity papers designed for inkjet printers may be white and weigh 24 lb/1300 ft² (90 g/m²). Commodity papers designed for use in laser or copier printers are also suitable for use in the present invention. Examples of suitable commodity papers include, but are not limited to, white papers such as Kodak Bright White Inkjet Paper, Hewlett-Packard Bright White Paper, Hammermill Ultra Premium Inkjet Paper, and Staples Printing Paper—Bright White.

The coating applied to the substrate may suitably produce a non-glossy or matte surface or finish to the substrate. As used herein, with respect to the finish or surface of the coated recording medium, “non-glossy” means a specular gloss of less than about 10% at 60°. Suitably, the specular gloss at 60° of the coated recording medium may be less than about 15%, less than about 13.5%, less than about 12%, less than about 10%, less than about 7.5% or less than about 5%. Suitably, the specular gloss at 75° of the coated recording medium may be less than about 15%, less than about 13.5%, less than about 12%, less than about 10%, less than about 7.5% or less than about 5%. As used herein, with respect to the finish or surface of the coated recording medium, “matte” means a specular gloss of less than about 10% at 75°. The specular gloss of a coated paper may be increased by calendaring the paper.

The recording medium described herein can be prepared by a method comprising (a) providing a substrate; (b) coating at least a portion of the substrate with the composition described herein to provide a coated substrate; and (c) optionally drying the composition on the substrate. Furthermore, the composition may be repeatedly applied to the substrate to provide a recording medium having a coating with a desired thickness.

Any suitable method can be used to coat a portion of the substrate, directly or indirectly, with the composition. Suitable methods include, but are not limited to, roll coating, blade coating, air knife coating, rod coating (e.g., using a Meyer rod or the like), bar coating, cast coating, gate roll coating, wire bar coating, short-dowel coating, slide hopper coating, curtain coating, flexographic coating, gravure coating, Komma coating, dip coating, size press coating in the manner of on- or off-machine, using a water box in the calandring operation, and die coating. Methods such as coating using the size press section of the paper machine during the manufacture of the paper may be particularly suitable. The coating composition applied to the substrate can be of any suitable thickness or amount. The coating composition is suitably applied to provide at least about 0.02, at least about 0.04, at least about 0.05, at least about 0.06, at least about 0.08, at least about 0.1, at least about 0.5, at least about 1, at least about 2, at least about 3, at least about 4, at least about 5, at least about 6, or at least about 7 g coating per m² of substrate. The coating may be suitably applied to provide less than about 30, less than about 25, less than about 20, less than about 15, less than about 10, less than about 8, less than about 5, less than about 3, less than about 2, less than about 1, less than about 0.8, less than about 0.6, less than about 0.5, less than about 0.4, less than about 0.3, less than about 0.2, or less than about 0.1 g coating per m² of substrate. The amount of coating containing the metal oxide per m² of substrate is referred to herein as the “coat weight.”

The coating composition may be applied to provide at least about 0.01, at least about 0.02, at least about 0.03, at least about 0.04, at least about 0.05, at least about 0.1, at least about 0.3, at least about 0.5, at least about 0.8, at least about 1, at least about 1.5, or at least about 2 g metal oxide per m² of substrate. The coating may be suitably applied to provide less than about 25, less than about 20, less than about 15, less than about 10, less than about 5, less than about 3, less than about 2, less than about 1, less than about 0.8, less than about 0.5, less than about 0.3, less than about 0.2, less than about 0.1, less than about 0.05, less than about 0.04, less than about 0.03, or less than about 0.02 g metal oxide per m² of substrate.

The inventor surprisingly and unexpectedly discovered that the application of coating compositions of the invention to a substrate such as paper in relatively small amounts, for example less than about 0.8 g/m², or more particularly at 0.05 to 0.5 g/m², caused paper to show improved receptivity to ink printed onto its surface with a better quality image. The inventor also surprisingly discovered that the coatings of the invention can be suitably applied to a substrate such as paper at the size press. Suitably, the size press is “in-line” with the paper machine such that the moving paper web may pass between the nips of two or more rotating rolls, such as steel rolls. The pressure (for example, hydraulic pressure) and temperature of the rolls suitably enable the coating to impregnate or remain near the surface of the paper. Suitable size presses include a rod metered size press, a gate roll size press or a blade metered size press. Other “on-line” suitable methods to apply coating compositions of the invention to substrates during the manufacturing process of the substrate include dip coating, application at the water box of the calendar stack and spray devices.

Coating compositions of the invention may be suitably applied before the calendaring step during the manufacture of a substrate such as paper. During the manufacture of paper, the calendaring step may compress the fibers, such as cellulose fibers, of the paper. This step may reduce the capacity of the paper to absorb ink by reducing the void volume of the paper. However, the metal oxides used in the coating compositions of the invention may not be compressed during the calendaring step, thereby retaining their void volume. While not wishing to be bound to any particular theory, the retention of the void volume of the metal oxides during the calendaring step may contribute to the superior ink absorption capacity of a paper coated before the calendaring step, and image quality of an image printed on a coated paper.

In contrast to pigments having a large particle size, which when incorporated at the size press may introduce manufacturing defects such as surface scratches, or process defects such as coating rejection at the nip, and in contrast to pigments which do not possess the particle structure to increase ink absorption, the inventor surprisingly discovered that the application of metal-oxide-containing coatings at the size press of a paper machine enables superior ink absorption on the paper using a variety of printers and liquid inks, with substantially few or no manufacturing defects. While not wishing to be bound by any particular theory, it is presumed that the small particle size and narrow distribution of the metal oxides allow for their application at the size press with substantially few or no introduction of manufacturing defects. The smaller particle size may also permit the use of higher concentrations of these compounds in the formulation of a coating on the size press, such that high coat weights may be achieved. The structure of fumed metal oxides may also improve the absorption of inks. The process of the invention may allow a paper manufacturer to economically produce a printing paper capable of accepting a wide variety of inks found in and used by the printing industry to produce a superior image.

The coated substrate can be subsequently coated again, with the same or a different coating to further enhance and compliment the absorptive properties that the fumed metal oxide coating delivers for inkjet printing. These coatings may, for example, be applied off-line from the paper manufacturing machinery. Suitable methods of application include, but are not limited to, roll coating, blade coating, air knife coating, rod coating (e.g., using a Meyer rod or the like), bar coating, cast coating, gate roll coating, wire bar coating, short-dowel coating, slide hopper coating, curtain coating, flexographic coating, gravure coating, Komma coating, dip coating, size press coating in the manner of on- or off-machine, using a water box in the calendaring operation, and die coating.

After application of the coating composition to the substrate, the coated substrate may be suitably dried using any suitable method or combination of methods to provide the recording medium. Suitable drying methods include, but are not limited to, air or convection drying (e.g., linear tunnel drying, arch drying, air-loop drying, sine curve air float drying, etc.), contact or conduction drying, and radiant-energy drying (e.g., infrared drying and microwave drying).

If the coating composition is applied to paper using a size press section of the paper making machine, suitably the paper may be subsequently subjected to a calendar stack. The calendar stack suitably increases the density of the paper web using pressure, moisture and heat, and may impart a smoothness and more uniform thickness to the paper. Paper smoothness and uniform thickness and density may be advantageous for many reasons, including, but not limited to, beneficial effects in the printing process, such as improvements in ink absorption rate and capacity in localized areas and reducing uneven ink uptake which may otherwise result in an increase of the mottle and grain properties of the printed image. However, in uncoated substrates, the calendar stack may also compress the substrate and reduce the ink absorption characteristics of the substrate, such capacity and rate.

The inventor has discovered that the calendaring step has minimal impact on the absorption characteristics of the fumed metal oxide layer. The presence of the fumed metal oxide layer thus allows the retention of absorption benefits that may be otherwise lost during the calendaring step. The manipulation of fumed metal oxide content and calendaring variables permits the manipulation of the ink absorption capacity, or void volume, of the coated substrate.

An image may be printed, directly or indirectly, onto the recording medium of the invention using one or more of a variety of printing techniques, including flexography, rotography, lithography, offset lithography, intaglio (gravure), letterpress, thermography, electrophotgraphy, and high speed digital (for example, using XEIKON™ printers, VERSAMARK™ printers or INDIGO™ printers) techniques.

The recording medium may suitably be used in color laser printers and copiers. For such applications, the coating of the recording medium may suitably comprise a cationic material such as AERODISP® WK 341 (cationized alumina doped silica dispersion), VP Disp WK 7330 (cationized mixed metal oxide dispersion) or W 630 (alumina dispersion).

The recording medium is particularly suited to receive an image from an ink jet printer. The metal oxide may separate the liquid phase of the ink from the colorant phase such that the colorant is rapidly immobilized on the recording medium, resulting in high image resolution, fast ink drying time, vibrant colors, waterfastness, or a combination thereof.

Images made using an ink jet printer on a recording medium comprising a coating composition of the invention are brighter, sharper and have a higher resolution than a comparable substrate that has not been coated with the composition of the invention.

The coating compositions may also improve the wick and bleed of images printed onto a coated substrate. Wick and bleed are evaluated by measuring the characteristics of a printed line with a known thickness (for example, 280 μm). Wick is a measurement of this line on paper. Bleed is a measurement of this line contained within a box of the other colors. The coating compositions may improve the wick of an image printed onto a substrate by at least about 5%, at least about 10%, at least about 20%, at least about 30%, at least about 40%, at least about 50%, or at least about 60%, when compared with a comparable uncoated substrate. The coating compositions may also improve the bleed of an image printed onto a substrate by at least about 5%, at least about 10%, at least about 20%, at least about 30%, at least about 40%, at least about 50%, or at least about 60%, when compared with a comparable uncoated substrate. Inks ink-jet printed on a coated substrate, compared with inks printed onto a comparable uncoated substrate, may show a reduction in bleeding and wicking of the ink of at least about 5 microns, at least about 10 microns, at least about 15 microns, at least about 20 microns, at least about 25 microns, at least about 30 microns, at least about 40 microns, or about at least 50 microns.

Inks ink-jet printed on a substrate coated with a coating composition of the invention, compared with inks printed onto a comparable uncoated substrate, may show an improvement in the raggedness of a line ink-jet printed onto the coated surface. Raggedness is a measure of the geometric distortion of an edge of the line from its ideal position. The amount of line raggedness may be reduced by at least about 1 micron, at least about 2 microns, at least about 3 microns, at least about 4 microns, at least about 5 microns, or at least about 6 microns.

Coating compositions of the invention may also improve the color gamut of the substrate. The color gamut of a substrate is the number of colors that can be accurately represented under a certain set of conditions. Compositions of the invention may improve the color gamut of a substrate by at least about 5%, at least about 10%, at least about 15%, at least about 20%, at least about 25%, at least about 30%, at least about 35, or at least about 40%, when compared with a comparable uncoated substrate.

Optical Density (OD) is the light that each primary color reflects and is measured by a densitometer. The OD is influenced by the type of paper, for example, the shade, smoothness, gloss, opacity and where the colorant is located for example, at the surface or in the body of the paper. Compositions of the invention may improve the OD of an image printed onto a substrate by at least about 5%, at least about 10%, at least about 15%, at least about 20%, or at least about 25%, when compared with a comparable uncoated substrate.

Mottle is a measure of large scale non-uniformity that occurs at a low spacial frequency (coarse scale noise) on a scale that is over 250 μm. Compositions of the invention may improve the mottle of an image printed onto a substrate by at least about 5%, at least about 10%, at least about 15%, at least about 20%, at least about 25%, or at least about 30%, when compared with a comparable uncoated substrate.

Graininess is the optical density non-uniformity that occurs at a high spacial frequency (fine scale noise) on a scale that is less than 250 μm. Compositions of the invention may improve the graininess of an image printed onto a substrate by at least about 5%, at least about 10%, at least about 20%, at least about 30%, at least about 40%, at least about 50%, or at least about 60%, when compared with a comparable uncoated substrate.

Blurriness corresponds to the width of the transition zone between the field and the line. Lower values are associated with better images. Compositions of the invention may improve the blurriness of an image printed onto a substrate by at least about 15%, at least about 18%, at least about 20%, at least about 22%, at least about 25%, at least about 27%, or at least about 30%, when compared with a comparable uncoated substrate.

Waterfastness is a relative term, measured herein using a “Drip Method.”

In this method, 250 μL of distilled water are applied in a steady stream on a block of color that is 4 mm in thickness. The OD is measured before and after the application of water and a ratio obtained. A 0% value signifies complete retention of the ink after exposure to water. The waterfastness of an image printed onto a substrate coated with compositions of the invention is suitably less than about 10%, less than about 8%, less than about 5%, less than about 3%, or less than about 2%.

Dry time is a relative term, measured herein by evaluating the amount of ink transferred to another “blotting” paper immediately upon exit from the printer. Substrates coated with compositions of the invention suitably produce instant dry times, do not increase the dry time of the substrates, and likely improve the dry time.

The following examples further illustrate the invention but should not be construed as in any way limiting its scope. Unless otherwise indicated, the inks used herein were those sold with the printers used herein.

### EXAMPLE 1

### Compositions Comprising an Alkaline Fumed Silica (Particle Size 120 nm) Dispersion

AERODISP® W 7520 (a low viscosity, slightly alkaline, water-based dispersion of AEROSIL® 200 (fumed silica having a particle size of 120 nm and a surface area of 200 m²/g)) was combined with CELVOL® 523 (polyvinyl alcohol), commercially available from Celanese Limited using a DISPERMAT® mixer commercially available from VMA-Getzmann GMBH with a high shear blade at a shear rate of 1200 inverse minutes. The proportions of AERODISP® and CELVOL® 523 were chosen such that the weight ratio of fumed silica to polyvinyl alcohol in the compositions was 2.5:1, 3.6:1, 5:1 or 10:1.

### EXAMPLE 2

### Compositions Comprising an Acidic Fumed Mixed Metal Oxides (Particle Size 180 nm) Dispersion

VP Disp WK 7330 (a slightly acidic, cationic, water-based dispersion of fumed mixed metal oxide) was combined with CELVOL® 523 (polyvinyl alcohol) using a DISPERMAT® mixer with a high shear blade at a shear rate of 1200 inverse minutes, or by vigorous shaking. The proportions of AERODISP® and CELVOL® 523 were chosen such that the weight ratio of fumed silica to polyvinyl alcohol in the composition was 10:1.

Portions of the resulting dispersion were combined with the cationic polymer Induquat 35L (polyDADMAC) commercially available from Indulor Chemie, GMBH. The proportions of Induquat 35L to VP Disp WK 7330 dispersion were 15, 30, 45 or 60 parts Induquat 35L per 100 parts dry weight VP Disp WK 7330. The acidic and cationic VP Disp WK 7330 dispersion allowed the easy incorporation of polyDADMAC into the coating formulation using a DISPERMAT® mixer with a high shear blade at a shear rate of 1200 inverse minutes, or by vigorously shaking.

### EXAMPLE 3

### Compositions Comprising a Polyvinyl Alcohol Cross-linker and an Acidic Fumed Silica Dispersion

A composition was made by combining CELVOL® 523 (polyvinyl alcohol) with water using a DISPERMAT® mixer with a high shear blade at a shear rate of 1200 inverse minutes, or by vigorous shaking. Glyoxal (Cartabond TSI), commercially available from Clariant Corporation, a crosslinking agent for polyvinyl alcohol (PVOH), was added to reduce the water solubility of PVOH. Glyoxyl was added at 5, 10 or 15 parts dry weight per 100 parts polyvinyl alcohol, and the composition was mixed using a DISPERMAT® mixer with a high shear blade at a shear rate of 1200 inverse minutes, or by vigorous shaking.

A portion of the resulting composition was combined with VP Disp WK 7330 (a slightly acidic, cationic, water-based dispersion of fumed mixed metal oxide) using a DISPERMAT® mixer with a high shear blade at a shear rate of 1200 inverse minutes, or by vigorous shaking.

### EXAMPLE 4

### Application of Coatings of Examples 1-3 to Standard Office Papers

Using the appropriate Meyer (wire wound) rod, the coatings of Examples 1-3 were drawn down onto the paper substrates. The coatings were dried with an industrial blow dryer until dry to the touch. The sheets were placed on a drying drum to complete drying.

### EXAMPLE 5

### Images Printed on Commercially Available General Purpose Papers For Home and Office Printing

Inks (black, cyan, magenta and yellow) commercially available from Epson or Hewlett Packard, were ink jet printed onto standard office commodity papers using an Epson Stylus Photo R200 printer under the Photo Quality setting or a Hewlett-Packard Photosmart 8250 printer under the Photo Quality setting. The papers used were Kodak Bright White Inkjet Paper (24 lb), Hewlett-Packard Bright White Paper (24 lb), Hammermill Ultra Premium Inkjet Paper (24 lb), Staples Printing Paper—Bright White (24 lb) and Georgia Pacific Spectrum DP (20 lb).

The color gamut, wick, wick blur, wick raggedness, positive and negative line deviation, bleed, bleed blur, bleed raggedness and bleed line width deviation were measured for images printed by each printer onto each of the papers. The results are presented in Table 1.

TABLE 1

| | | | | |
|---|---|---|---|---|
| | | | | Georgia- |
| Paper | Kodak | Hammermill | Staples | Pacific |

A. PRINT QUALITY (Epson Stylus Photo R200)

| | | | | |
|---|---|---|---|---|
| Color Gamut Area | 5804 | 5859 | 5560 | 5543 |
| Black OD | 1.22 | 1.24 | 1.22 | 1.19 |
| Black Grain (% R) | 0.8 | 0.8 | 1.0 | 1.1 |
| Black Mottle (% R) | 0.4 | 0.3 | 0.4 | 0.4 |
| C, M, Y OD (avg) | 0.84 | 0.83 | 0.80 | 0.80 |
| C, M, Y Grain (% R) | 2.3 | 2.5 | 2.5 | 2.7 |
| C, M, Y Mottle (% R) | 1.2 | 1.1 | 1.3 | 1.3 |
| Wick (um) | 80 | 81 | 72 | 83 |
| Wick Blur (%) | 44% | 43% | 42% | 49% |
| Wick Line Rag (um) | 9.7 | 10.1 | 9.2 | 10.9 |
| Pos Live Dev (um) | 66 | 66 | 57 | 68 |
| Neg Line Dev (um) | 95 | 95 | 86 | 97 |
| Bleed (um) | 91 | 89 | 79 | 88 |
| Bleed Blur (%) | 47% | 49% | 43% | 50% |
| Bleed Rag (um) | 13.0 | 12.9 | 11.2 | 14.7 |
| Line Width Deviation (um) | 100 | 100 | 86 | 100 |
| Waterfastness (% Loss) | 32% | 14% | 6% | 6% |
| Drytime (mm) | 0 | 0 | 0 | 0 |

B. PRINT QUALITY (HP Photosmart 8250)

| | | | | |
|---|---|---|---|---|
| Color Gamut Area | 5975 | 6005 | 6042 | 5805 |
| Black OD | 1.13 | 1.13 | 1.15 | 1.15 |
| Black Grain (% R) | 1.27 | 1.27 | 1.22 | 1.39 |
| Black Mottle (% R) | 0.66 | 0.47 | 0.52 | 0.54 |
| C, M, Y OD (avg) | 1.24 | 1.23 | 1.25 | 1.23 |
| C, M, Y Grain (% R) | 1.65 | 1.74 | 1.74 | 1.84 |
| C, M, Y Mottle (% R) | 0.73 | 0.67 | 0.69 | 0.73 |
| Wick (um) | 73 | 67 | 69 | 80 |
| Wick Blur (%) | 40% | 38% | 37% | 44% |
| Wick Line Rag (um) | 9 | 10 | 8 | 10 |
| Pos Live Dev (um) | 55 | 51 | 51 | 66 |
| Neg Line Dev (um) | 90 | 83 | 87 | 93 |
| Bleed (um) | 63 | 61 | 55 | 62 |
| Bleed Blur (%) | 40% | 41% | 37% | 44% |
| Bleed Rag (um) | 12 | 13 | 11 | 14 |
| Line Width Deviation (um) | 75 | 76 | 66 | 77 |
| Waterfastness (% Loss) | 29.9% | 27.1% | 22.1% | 18.5% |
| Drytime (mm) | 0 | 0 | 0 | 0 |

### EXAMPLE 6

### Application of the Composition of Example 1 to a Standard Office Paper (Georgia Pacific Spectrum DP (20 lb))

20 lb Georgia Pacific Spectrum DP is a commodity paper designed for general office printing. The coating composition of Example 1, at the four different pigment-binder ratios of 2.5:1, 3.6:1. 5.0:1 and 10.0:1, was applied to 20 lb Georgia Pacific Spectrum DP, keeping the coat weight roughly constant for each. The coating compositions, properties and process used to coat the paper are summarized in Table 2.

TABLE 2

| | Controls | | Pigment - Binder Ratios | | | |
|---|---|---|---|---|---|---|
| | Base Paper | PVOH | 2.5:1 | 3.6:1 | 5.0:1 | 10:1 |
| COATING (Dry Parts) | | | | | | |
| Celvol 523 | n/a | 100 | 40.0 | 27.5 | 20.0 | 10.0 |
| Aerodisp W 7520 | n/a | 0 | 100 | 100 | 100 | 100 |
| COATING PROPERTIES | | | | | | |
| Brookfield Viscosity (100 rpm) | n/a | n/a | 120 | 83 | 64 | 48 |
| Coating Solids (%) | n/a | 12.37 | 16.51 | 17.89 | 18.39 | 19.51 |
| pH | n/a | n/a | 9.52 | 9.57 | 9.61 | 9.67 |
| COATING PROCESS | | | | | | |
| Rod # used | n/a | 5 | 5 | 5 | 5 | 5 |
| Coat Weight (g/m²) | n/a | 3.61 | 3.89 | 3.82 | 3.83 | 3.75 |

Ink (black, cyan, magenta and yellow) was ink jet printed onto the papers coated according to Table 2 using an Epson Stylus Photo R200 printer under the Photo Quality setting. Print quality properties of images were analyzed and are summarized in Table 3.

TABLE 3

| | Controls | | Pigment - Binder Series | | | |
|---|---|---|---|---|---|---|
| PRINT QUALITY | Base Paper | PVOH | 2.5:1 | 3.6:1 | 5.0:1 | 10:1 |
| Color Gamut Area | 5543 | 6538 | 7336 | 7343 | 7608 | 7951 |
| Black OD | 1.18 | 1.42 | 1.50 | 1.49 | 1.55 | 1.57 |
| Black Grain (% R) | 1.4 | 1.5 | 0.6 | 0.5 | 0.5 | 0.9 |
| Black Mottle (% R) | 0.6 | 0.7 | 0.3 | 0.2 | 0.2 | 0.4 |
| C, M, Y OD (avg) | 0.89 | 0.94 | 1.06 | 1.04 | 1.05 | 1.05 |
| C, M, Y Grain (% R) | 2.6 | 2.5 | 1.4 | 1.3 | 1.3 | 1.6 |
| C, M, Y Mottle (% R) | 1.3 | 1.2 | 0.8 | 0.8 | 0.7 | 0.8 |
| Wick (μm) | 83 | 43 | 46 | 62 | 56 | 56 |
| Wick Blur (%) | 50% | 41% | 35% | 32% | 31% | 34% |
| Wick Line Rag (μm) | 12.1 | 8.3 | 6.3 | 6.3 | 5.6 | 5.8 |
| Pos Live Dev (μm) | 69 | 39 | 30 | 50 | 38 | 43 |
| Neg Line Dev (μm) | 98 | 46 | 62 | 73 | 74 | 69 |
| Bleed (μm) | 73 | 39 | 67 | 66 | 63 | 56 |
| Bleed Blur (%) | 51% | 41% | 44% | 40% | 37% | 40% |
| Bleed Rag (μm) | 15.5 | 9.4 | 10.7 | 9.4 | 8.0 | 8.2 |
| Line Width Deviation (μm) | 88 | 45 | 77 | 74 | 70 | 63 |
| Waterfastness (% Loss) | 7% | 37% | 25% | 30% | 26% | 25% |
| Drytime (mm) | 0 | 41 | 0 | 0 | 0 | 0 |

The composition of Example 1, at a pigment-binder ratios of 10.0:1, was also applied to 20 lb Georgia Pacific Spectrum DP, at three different coat weights. The coating compositions, properties and process used to coat the paper are summarized in Table 4.

TABLE 4

| | Controls | | Coat Weight (g/m²) | | |
|---|---|---|---|---|---|
| | Base Paper | PVOH | 1.50 | 2.23 | 3.63 |
| COATING | | | | | |
| (Dry Parts) | | | | | |
| Celvol 523 | n/a | 100 | 10.0 | 10.0 | 10.0 |
| Aerodisp | n/a | 0 | 100 | 100 | 100 |
| W 7520 | | | | | |
| COATING | | | | | |
| PROPERTIES | | | | | |
| Coating | n/a | 12.37 | 6.96 | 6.96 | 6.96 |
| Solids (%) | | | | | |
| pH | n/a | n/a | 9.67 | 9.67 | 9.67 |
| COATING | | | | | |
| PROCESS | | | | | |
| Rod # used | n/a | 5 | 5 | 5 | 5 |

Ink (black, cyan, magenta and yellow) was ink jet printed onto the papers coated according to Table 4 using an Epson Stylus Photo R200 printer under the Photo Quality setting. Print quality properties of images were analyzed and are summarized in Table 5.

TABLE 5

| | Controls | | Coat Weight (g/m²) | | |
|---|---|---|---|---|---|
| PRINT QUALITY | Base Paper | PVOH | 1.50 | 2.23 | 3.63 |
| Color Gamut Area | 5543 | 6538 | 6960 | 7491 | 7695 |
| Black OD | 1.18 | 1.42 | 1.43 | 1.64 | 1.69 |
| Black Grain (% R) | 1.4 | 1.5 | 1.0 | 0.7 | 0.5 |
| Black Mottle (% R) | 0.6 | 0.7 | 0.5 | 0.3 | 0.3 |
| C, M, Y OD (avg) | 0.89 | 0.94 | 1.04 | 1.12 | 1.12 |
| C, M, Y Grain | 2.6 | 2.5 | 1.8 | 1.6 | 1.4 |
| (% R) | | | | | |
| C, M, Y Mottle | 1.3 | 1.2 | 0.8 | 0.8 | 0.8 |
| (% R) | | | | | |
| Wick (μm) | 83 | 43 | 80 | 69 | 56 |
| Wick Blur (%) | 50% | 41% | 39% | 36% | 34% |
| Wick Line Rag (μm) | 12.1 | 8.3 | 9.4 | 7.6 | 6.4 |
| Pos Live Dev (μm) | 69 | 39 | 88 | 73 | 52 |
| Neg Line Dev (μm) | 98 | 46 | 71 | 64 | 60 |
| Bleed (μm) | 73 | 39 | 71 | 66 | 61 |
| Bleed Blur (%) | 51% | 41% | 40% | 40% | 37% |
| Bleed Rag (μm) | 15.5 | 9.4 | 14.0 | 10.1 | 10.0 |
| Line Width | 88 | 45 | 94 | 81 | 72 |
| Deviation (μm) | | | | | |
| Waterfastness | 7% | 37% | 24% | 38% | 29.7% |
| (% Loss) | | | | | |
| Drytime (mm) | 0 | 41 | 0 | 0 | 0 |

### EXAMPLE 7

### Application of the compositions of Example 2 to a Standard Office Paper (Georgia Pacific Spectrum DP (20 lb))

The coating composition of Example 2, containing VP Disp WK 7330, CELVOL® 523 and Induquat 35L (polyDADMAC) at a ratio of 60 parts Induquat 35L per 100 parts dry weight VP Disp WK 7330 was applied to 20 lb Georgia Pacific Spectrum DP at four different coat weights. The coating compositions, properties and process used to coat the paper are summarized in Table 6.

TABLE 6

| | Controls | Coat Weight (g/m²) | | | |
|---|---|---|---|---|---|
| | Base Paper | 0.65 | 0.90 | 1.49 | 1.93 |
| COATING (Dry Parts) | | | | | |
| Celvol 523 | n/a | 10 | 10 | 10 | 10 |
| VP Disp WK 7330 | n/a | 100 | 100 | 100 | 100 |
| Induquat 35L | n/a | 60 | 60 | 60 | 60 |
| COATING PROP | | | | | |
| Pigment - Binder Ratio | n/a | 10.0 | 10.0 | 10.0 | 10.0 |
| Coating Solids (%) | n/a | 4.1 | 4.1 | 4.1 | 4.1 |
| COATING PROCESS | | | | | |
| Rod # used | n/a | 2.5 | 5 | 10 | 15 |

Inks (black, cyan, magenta and yellow) commercially available from Epson or Hewlett Packard were ink jet printed onto the papers coated according to Table 6 using an Epson Stylus Photo R200 printer under the Photo Quality setting, or a Hewlett-Packard Photosmart 8250 printer under the Photo Quality setting. Print quality properties of images were analyzed and are summarized in Tables 7 and 8.

TABLE 7

| PRINT QUALITY | Controls | | Coat Weight (g/m²) | | | |
|---|---|---|---|---|---|---|
| USING EPSON R200 | Base Paper | PVOH | 0.65 | 0.90 | 1.49 | 1.93 |
| Color Gamut Area | 5374 | 6538 | 6435 | 6498 | 6627 | 6757 |
| Black OD | 1.19 | 1.42 | 1.38 | 1.40 | 1.40 | 1.45 |
| Black Grain (% R) | 1.1 | 1.5 | 1.1 | 1.0 | 1.1 | 0.9 |
| Black Mottle (% R) | 0.4 | 0.7 | 0.6 | 0.5 | 0.5 | 0.5 |
| C, M, Y OD (avg) | 0.80 | 0.94 | 0.90 | 0.92 | 0.94 | 0.96 |
| C, M, Y Grain (% R) | 2.7 | 2.5 | 2.3 | 2.4 | 2.4 | 2.4 |
| C, M, Y Mottle (% R) | 1.3 | 1.2 | 1.0 | 1.2 | 1.1 | 1.1 |
| Wick (μm) | 83 | 43 | 85 | 82 | 74 | 75 |
| Wick Blur (%) | 49% | 41% | 48% | 47% | 46% | 45% |
| Wick Line Rag (μm) | 10.9 | 8.3 | 11.9 | 11.9 | 10.1 | 11.0 |
| Pos Live Dev (μm) | 68 | 39 | 76 | 71 | 60 | 62 |
| Neg Line Dev (μm) | 97 | 46 | 94 | 94 | 89 | 87 |
| Bleed (μm) | 88 | 39 | 89 | 84 | 71 | 78 |
| Bleed Blur (%) | 50% | 41% | 47% | 48% | 44% | 46% |
| Bleed Rag (μm) | 14.7 | 9.4 | 16.4 | 15.4 | 14.8 | 13.8 |
| Line Width Deviation (μm) | 100 | 45 | 101 | 97 | 85 | 92 |
| Waterfastness (% Loss) | 6% | 37% | 2% | 0% | 2% | 2% |
| Drytime (mm) | 0 | 41 | 0 | 0 | 0 | 0 |

TABLE 8

| PRINT QUALITY | Control | Coat Weight (g/m²) | | | |
|---|---|---|---|---|---|
| USING HP 8250 | Base Paper | 0.65 | 0.90 | 1.49 | 1.93 |
| Color Gamut Area | 5805 | 6435 | 6498 | 6627 | 6757 |
| Black OD | 1.15 | 1.38 | 1.40 | 1.40 | 1.45 |
| Black Grain (% R) | 1.4 | 1.1 | 1.0 | 1.1 | 0.9 |
| Black Mottle (% R) | 0.5 | 0.6 | 0.5 | 0.5 | 0.5 |
| C, M, Y OD (avg) | 1.23 | 0.90 | 0.92 | 0.94 | 0.96 |
| C, M, Y Grain | 1.8 | 2.3 | 2.4 | 2.4 | 2.4 |
| (% R) | | | | | |
| C, M, Y Mottle | 0.7 | 1.0 | 1.2 | 1.1 | 1.1 |
| (% R) | | | | | |
| Wick (μm) | 80 | 85 | 82 | 74 | 75 |
| Wick Blur (%) | 44% | 48% | 47% | 46% | 45% |
| Wick Line Rag (μm) | 9.9 | 11.9 | 11.9 | 10.1 | 11.0 |
| Pos Live Dev (μm) | 66 | 76 | 71 | 60 | 62 |
| Neg Line Dev (μm) | 93 | 94 | 94 | 89 | 87 |
| Bleed (μm) | 62 | 89 | 84 | 71 | 78 |
| Bleed Blur (%) | 44% | 47% | 48% | 44% | 46% |
| Bleed Rag (μm) | 13.6 | 16.4 | 15.4 | 14.8 | 13.8 |
| Line Width | 77 | 101 | 97 | 85 | 92 |
| Deviation (μm) | | | | | |
| Waterfastness | 19% | 2% | 0% | 2% | 2% |
| (% Loss) | | | | | |
| Drytime (mm) | 0 | 0 | 0 | 0 | 0 |

### EXAMPLE 8

### Composition Comprising an Acidic Fumed Silica Dispersion, a Binder, a PolyDADMAC and a Foam Control Agent

VP Disp WK 7330 (a slightly acidic, cationic, water-based dispersion of fumed mixed metal oxide) was combined with CELVOL® 523 (polyvinyl alcohol) using a DISPERMAT® mixer with a high shear blade at a shear rate of 1200 inverse minutes, or by vigorous shaking. Different compositions were made wherein the proportions of AERODISP® and CELVOL® 523 were chosen such that the coat weight (g/m²) ratio of fumed silica to polyvinyl alcohol in the composition was 0.7:1, 1.0:1, 1.2:1, 1.6:1, 1.8:1, 2.6:1, 4.2:1 and 5.8:1.

A portion of each of the resulting dispersions was combined with the cationic polymer CATIOFAST CS (a polyDADMAC) commercially available from BASF. The proportion of CATIOFAST CS to VP Disp WK 7330 dispersion was 2.4 parts per 100 parts dry weight. The acidic and cationic VP Disp WK 7330 dispersion allowed the easy incorporation of the polyDADMAC into the coating formulation using a DISPERMAT® mixer with a high shear blade at a shear rate of 1200 inverse minutes, or by vigorously shaking. DYNOL 604 commercially available from Air Products, a foam control agent, was also added to each composition at 0.1 parts per 100 parts dry weight VP Disp WK 7330 dispersion.

### EXAMPLE 9

### Application of the Compositions of Example 8 Using a Simulated Size-Press Treatment to a Standard Office Paper (Georgia-Pacific Spectrum DP Paper)

The compositions of Example 8 were applied to Georgia-Pacific Spectrum DP Paper using a simulated calendaring process. Two sets of papers were treated with a coating at 0.33% solids. Rod numbers 5, 10 and 15 were used to achieve the varying coat weights. One set of papers was then passed through a pair of steel rolls twice at a nip pressure of 19 bar and roll temperature of 58° C. to simulate the calendaring process. The other set did not undergo simulated calendaring treatment. The coating compositions, properties and process used to coat the paper are summarized in Table 9.

TABLE 9

| | NOT CALENDARED | | | | CALENDARED | | | |
|---|---|---|---|---|---|---|---|---|
| | | Coat Weight (g/m²) | | | Base | Coat Weight (g/m²) | | |
| | Base Paper | 0.41 | 0.73 | 1.09 | Paper | 0.41 | 0.73 | 1.09 |
| COATING (Dry Parts) | | | | | | | | |
| Celvol 523 | n/a | 24.00 | 24.00 | 24.00 | n/a | 24.00 | 24.00 | 24.00 |
| VP Disp WK 7330 | n/a | 100 | 100 | 100 | n/a | 100 | 100 | 100 |
| Catiofast CS | n/a | 2.4 | 2.4 | 2.4 | n/a | 2.4 | 2.4 | 2.4 |
| Dynol 604 | n/a | 0.1 | 0.1 | 0.1 | n/a | 0.1 | 0.1 | 0.1 |
| COATING PROP | | | | | | | | |
| Pigment - Binder Ratio | n/a | 4.2 | 4.2 | 4.2 | n/a | 4.2 | 4.2 | 4.2 |
| Coating Solids (%) | n/a | 0.33 | 0.33 | 0.33 | n/a | 0.33 | 0.33 | 0.33 |
| COATING PROCESS | | | | | | | | |
| Rod # used | n/a | 5 | 10 | 15 | n/a | 5 | 10 | 15 |

Ink (black, cyan, magenta and yellow) was ink jet printed onto the papers coated according to Table 4 using an Epson Stylus Photo R200 printer under the Photo Quality setting. Print quality properties of images were analyzed and are summarized in Table 10.

TABLE 10

| | NOT CALENDARED | | | | CALENDARED | | | |
|---|---|---|---|---|---|---|---|---|
| PRINT QUALITY | Base | Coat Weight (g/m²) | | | Base | Coat Weight (g/m²) | | |
| USING EPSON R20) | Paper | 0.41 | 0.73 | 1.09 | Paper | 0.41 | 0.73 | 1.09 |
| Color Gamut Area | 6055 | 6465 | 6582 | 6829 | 5920 | 6339 | 6492 | 6602 |
| Black OD | 1.25 | 1.26 | 1.28 | 1.32 | 1.22 | 1.29 | 1.30 | 1.32 |
| Black Grain (% R) | 1.1 | 1.2 | 1.1 | 0.9 | 1.2 | 0.9 | 0.9 | 0.8 |
| Black Mottle (% R) | 0.5 | 0.5 | 0.5 | 0.4 | 0.5 | 0.4 | 0.3 | 0.3 |
| C, M, Y OD (avg) | 0.96 | 1.00 | 1.02 | 1.05 | 0.94 | 1.00 | 1.01 | 1.02 |
| C, M, Y Grain (% R) | 2.1 | 2.1 | 2.0 | 1.9 | 2.2 | 1.9 | 1.8 | 1.7 |
| C, M, Y Mottle (% R) | 1.0 | 0.9 | 0.9 | 0.9 | 1.1 | 0.9 | 0.9 | 0.8 |
| Wick (μm) | 79 | 76 | 77 | 77 | 82 | 93 | 88 | 87 |
| Wick Blur (%) | 49 | 48 | 47 | 45 | 48 | 50 | 47 | 47 |
| Wick Line Rag (μm) | 10.2 | 9.3 | 9.0 | 8.9 | 10 | 11 | 9 | 9 |
| Pos Live Dev (μm) | 56 | 54 | 56 | 59 | 59 | 74 | 70 | 68 |
| Neg Line Dev (μm) | 101 | 98 | 97 | 95 | 104 | 112 | 107 | 106 |
| Bleed (μm) | 74 | 72 | 75 | 70 | 70 | 72 | 75 | 70 |
| Bleed Blur (%) | 50 | 48 | 50 | 47 | 49 | 48 | 50 | 47 |
| Bleed Rag (μm) | 13.4 | 12.3 | 12.3 | 12.2 | 12 | 12 | 12 | 12 |
| Line Width Deviation (μm) | 87 | 88 | 90 | 85 | 83 | 88 | 90 | 85 |
| Waterfastness (% Loss) | 9.4 | 7.8 | 9.0 | 6.6 | 9 | 10 | 10 | 15 |
| Drytime (mm) | 0 | 0 | 0 | 0 | 0 | 0 | 0 | 0 |

### EXAMPLE 10

### Application of the Compositions of Example 2 Using a Simulated Size-Press Treatment to a Standard Office Paper (24# Staples Printing Paper)

The coating compositions of Example 2, containing VP Disp WK 7330, CELVOL® 523 and Induquat 35L (polyDADMAC) at various ratios of Induquat 35L to VP Disp WK 7330 were applied to 24# Staples printing paper, commercially available from Staples, at a lower set of coat weights (0.68, 0.73, 0.87, 0.70 and 1.05 g/m²; average 0.81 g/m²) and a higher set of coat weights (1.90, 1.50, 1.43, 1.63 and 1.77 g/m²; average 1.65 g/m²). The coating compositions, properties and process used to coat the paper for the lower coat weight set are summarized in Table 11.

TABLE 11

| | Controls | Lower Coat Weights (g/m²) | | | | |
|---|---|---|---|---|---|---|
| | Base Paper | 0.68 | 0.73 | 0.87 | 0.7 | 1.05 |
| COATING (Dry Parts) | | | | | | |
| Celvol 523 | n/a | 10 | 10 | 10 | 10 | 10 |
| VP Disp WK 7330 | n/a | 100 | 100 | 100 | 100 | 100 |
| Induquat 35L | n/a | 0 | 60 | 45 | 30 | 15 |
| COATING | | | | | | |
| PROPERTIES | | | | | | |
| Pigment-Binder Ratio | n/a | 10.0 | 10.0 | 10.0 | 10.0 | 10.0 |
| Coating Solids (%) | n/a | ~4% | ~4% | ~4% | ~4% | ~4% |
| COATING PROCESS | | | | | | |
| Rod # used | n/a | 3 | 3 | 3 | 3 | 3 |

Ink (black, cyan, magenta and yellow) commercially available from Epson or Hewlett Packard was ink jet printed onto the papers coated according to Table 11 using an Epson Stylus Photo R200 printer under the Photo Quality setting, or a Hewlett-Packard Photosmart 8250 printer under the Photo Quality setting. Print quality properties of images were analyzed and are summarized in Tables 12 and 13.

TABLE 12

| | Controls | | | | | |
|---|---|---|---|---|---|---|
| PRINT QUALITY | Base | Coat Weight (g/m²) | | | | |
| USING EPSON R200 | Paper | 0.68 | 0.73 | 0.87 | 0.7 | 1.05 |
| Color Gamut Area | 5560 | 7275 | 6652 | 7147 | 6747 | 6794 |
| Black OD | 1.22 | 1.46 | 1.31 | 1.47 | 1.36 | 1.38 |
| Black Grain (% R) | 1.0 | 0.6 | 0.6 | 0.7 | 0.8 | 0.8 |
| Black Mottle (% R) | 0.4 | 0.3 | 0.4 | 0.3 | 0.4 | 0.4 |
| C, M, Y OD (avg) | 0.80 | 0.96 | 0.94 | 0.98 | 0.93 | 0.93 |
| C, M, Y Grain (% R) | 2.5 | 2.1 | 2.0 | 2.1 | 2.3 | 2.2 |
| C, M, Y Mottle (% R) | 1.3 | 0.9 | 1.0 | 0.9 | 1.0 | 1.0 |
| Wick (μm) | 72 | 84 | 86 | 71 | 76 | 88 |
| Wick Blur (%) | 42% | 36% | 39% | 36% | 41% | 42% |
| Wick Line Rag (μm) | 9.2 | 9.1 | 11.0 | 9.0 | 10.3 | 10.7 |
| Pos Live Dev (μm) | 57 | 64 | 64 | 51 | 57 | 66 |
| Neg Line Dev (μm) | 86 | 104 | 108 | 91 | 94 | 111 |
| Bleed (μm) | 79 | 77 | 72 | 72 | 79 | 86 |
| Bleed Blur (%) | 43% | 39% | 43% | 40% | 44% | 44% |
| Bleed Rag (μm) | 11.2 | 11.1 | 12.1 | 11.2 | 13.0 | 13.2 |
| Line Width Deviation (μm) | 86 | 86 | 81 | 80 | 91 | 97 |
| Waterfastness (% Loss) | 5.7% | 13.8% | 1.1% | 0% | 3.0% | 0.8% |
| Drytime (mm) | 0 | 0 | 0 | 0 | 0 | 0 |

TABLE 13

| PRINT QUALITY | Controls | Coat Weight (g/m²) | | | | |
|---|---|---|---|---|---|---|
| USING HP 8250 | Base Paper | 0.68 | 0.73 | 0.87 | 0.7 | 1.05 |
| Color Gamut Area | 6042 | 6861 | 6501 | 6833 | 6669 | 6760 |
| Black OD | 1.15 | 1.31 | 1.20 | 1.34 | 1.23 | 1.23 |
| Black Grain (% R) | 1.2 | 0.8 | 1.1 | 0.8 | 1.1 | 1.1 |
| Black Mottle (% R) | 0.5 | 0.4 | 0.5 | 0.3 | 0.6 | 0.5 |
| C, M, Y OD (avg) | 1.25 | 1.45 | 1.34 | 1.69 | 1.34 | 1.36 |
| C, M, Y Grain (% R) | 1.7 | 0.9 | 1.4 | 1.2 | 1.4 | 1.4 |
| C, M, Y Mottle (% R) | 0.7 | 0.5 | 0.6 | 0.5 | 0.6 | 0.6 |
| Waterfastness (% Loss) | | 30.2% | 4.2% | 6.7% | 6.6% | 15.3% |

The coating compositions, properties and process used to coat the paper for the higher coat weight set are summarized in Table 14.

TABLE 14

| | Controls | Higher Coat Weights (g/m²) | | | | |
|---|---|---|---|---|---|---|
| | Base Paper | 1.90 | 1.50 | 1.43 | 1.63 | 1.77 |
| COATING (Dry Parts) | | | | | | |
| Celvol 523 | n/a | 10 | 10 | 10 | 10 | 10 |
| VP Disp WK 7330 | n/a | 100 | 100 | 100 | 100 | 100 |
| Induquat 35L | n/a | 0 | 60 | 45 | 30 | 15 |
| COATING | | | | | | |
| PROPERTIES | | | | | | |
| Pigment-Binder Ratio | n/a | 10.0 | 10.0 | 10.0 | 10.0 | 10.0 |
| Coating Solids (%) | n/a | ~4% | ~4% | ~4% | ~4% | ~4% |
| COATING PROCESS | | | | | | |
| Rod # used | n/a | 10 | 10 | 10 | 10 | 10 |

Ink (black, cyan, magenta and yellow) was ink jet printed onto the papers coated according to Table 14 using an Epson Stylus Photo R200 printer under the Photo Quality setting, or a Hewlett-Packard Photosmart 8250 printer under the Photo Quality setting. Print quality properties of images were analyzed and are summarized in Tables 15 and 16.

TABLE 15

| | Controls | | | | | |
|---|---|---|---|---|---|---|
| PRINT QUALITY | Base | Coat Weight (g/m²) | | | | |
| USING EPSON R200 | Paper | 1.90 | 1.50 | 1.43 | 1.63 | 1.77 |
| Color Gamut Area | 5560 | 7909 | 7604 | 7049 | 6935 | 7070 |
| Black OD | 1.22 | 1.58 | 1.52 | 1.41 | 1.41 | 1.45 |
| Black Grain (% R) | 1.0 | 0.6 | 0.6 | 0.8 | 0.9 | 0.7 |
| Black Mottle (% R) | 0.4 | 0.3 | 0.3 | 0.4 | 0.4 | 0.3 |
| C, M, Y OD (avg) | 0.80 | 1.01 | 1.07 | 0.97 | 0.95 | 0.96 |
| C, M, Y Grain (% R) | 2.5 | 2.2 | 2.1 | 2.2 | 2.4 | 2.3 |
| C, M, Y Mottle (% R) | 1.3 | 1.0 | 0.9 | 1.0 | 1.1 | 1.0 |
| Wick (μm) | 72 | 65 | 76 | 73 | 77 | 73 |
| Wick Blur (%) | 42% | 32% | 35% | 41% | 42% | 39% |
| Wick Line Rag (μm) | 9.2 | 7.8 | 10.1 | 10.3 | 10.1 | 9.6 |
| Pos Live Dev (μm) | 57 | 48 | 55 | 51 | 53 | 59 |
| Neg Line Dev (μm) | 86 | 83 | 97 | 94 | 102 | 87 |
| Bleed (μm) | 79 | 72 | 58 | 77 | 77 | 80 |
| Bleed Blur (%) | 43% | 36% | 37% | 43% | 43% | 42% |
| Bleed Rag (μm) | 11.2 | 11.0 | 12.4 | 13.6 | 13.4 | 13.7 |
| Line Width Deviation (μm) | 86 | 79 | 70 | 85 | 88 | 89 |
| Waterfastness (% Loss) | 5.7% | 14.0% | 8.7% | 1.4% | 0% | 2.4% |
| Drytime (mm) | 0 | 0 | 0 | 0 | 0 | 0 |

TABLE 16

| | Controls | | | | | |
|---|---|---|---|---|---|---|
| PRINT QUALITY | Base | Coat Weight (g/m²) | | | | |
| USING HP 8250 | Paper | 0.68 | 0.73 | 0.87 | 0.7 | 1.05 |
| Color Gamut Area | 6042 | 7384 | 7351 | 7039 | 6979 | 7149 |
| Black OD | 1.15 | 1.41 | 1.39 | 1.29 | 1.29 | 1.30 |
| Black Grain (% R) | 1.2 | 0.6 | 1.0 | 1.0 | 1.1 | 1.0 |
| Black Mottle (% R) | 0.5 | 0.4 | 0.3 | 0.4 | 0.5 | 0.5 |
| C, M, Y OD (avg) | 1.25 | 1.49 | 1.42 | 1.38 | 1.37 | 1.39 |
| C, M, Y Grain (% R) | 1.7 | 0.9 | 1.1 | 1.2 | 1.3 | 1.3 |
| C, M, Y Mottle (% R) | 0.7 | 0.5 | 0.5 | 0.5 | 0.6 | 0.6 |
| Waterfastness (% Loss) | | 18.8% | 4.9% | 4.9% | 6.9% | 10.6% |

### EXAMPLE 11

### Application of the Compositions of Example 8 to a Ink Jet Paper (Hammermill Ultra Premium Ink Jet Paper)

The compositions of Example 8 were applied to Hammermill Ultra Premium-Ink Jet Paper at different cat weights. Coating was added to the paper by using a number 5 rod. The coating compositions, properties and process used to coat the paper are summarized in Table 17

TABLE 17

| | Controls | | | | | | | | |
|---|---|---|---|---|---|---|---|---|---|
| | Base | Coat Weight (g/m²) | | | | | | | |
| | Paper | 5.79 | 4.20 | 2.60 | 1.76 | 1.60 | 1.22 | 1.03 | 0.74 |
| COATING (Dry | | | | | | | | | |
| Parts) | | | | | | | | | |
| Celvol 523 | n/a | 24.0 | 24.0 | 24.0 | 24.0 | 24.0 | 24.0 | 24.0 | 24.0 |
| VP Disp WK 7330 | n/a | 100 | 100 | 100 | 100 | 100 | 100 | 100 | 100 |
| Catiofast CS | n/a | 2.4 | 2.4 | 2.4 | 2.4 | 2.4 | 2.4 | 2.4 | 2.4 |
| Dynol 604 | n/a | 0.1 | 0.1 | 0.1 | 0.1 | 0.1 | 0.1 | 0.1 | 0.1 |
| COATING | | | | | | | | | |
| PROPERTIES | | | | | | | | | |
| Pigment-Binder Ratio | n/a | 4.2 | 4.2 | 4.2 | 4.2 | 4.2 | 4.2 | 4.2 | 4.2 |
| Coating Solids (%) | n/a | 20.72 | 16.22 | 13.48 | 10.40 | 6.81 | 0.84 | 0.18 | 4.16 |
| COATING PROCESS | | | | | | | | | |
| Rod # used | n/a | 5 | 5 | 5 | 5 | 5 | 5 | 5 | 5 |

Ink (black, cyan, magenta and yellow) was ink jet printed onto the papers coated according to Table 4 using an Epson Stylus Photo R200 printer under the Photo Quality setting. Print quality properties of images were analyzed and are summarized in Table 18.

TABLE 18

| | Controls | | | | | | | | |
|---|---|---|---|---|---|---|---|---|---|
| PRINT QUALITY | Base | Coat Weight (g/m²) | | | | | | | |
| USING EPSON R200 | Paper | 5.79 | 4.20 | 2.60 | 1.76 | 1.60 | 1.22 | 1.03 | 0.74 |
| Color Gamut Area | 5374 | 8846 | 9031 | 8606 | 8261 | 8035 | 7187 | 5956 | 8106 |
| Black OD | 1.19 | 1.85 | 1.90 | 1.86 | 1.70 | 1.66 | 1.43 | 1.24 | 1.61 |
| Black Grain (% R) | 1.1 | 0.4 | 0.4 | 0.5 | 0.6 | 0.7 | 0.9 | 1.2 | 0.7 |
| Black Mottle (% R) | 0.4 | 0.2 | 0.2 | 0.2 | 0.3 | 0.3 | 0.4 | 0.5 | 0.4 |
| C, M, Y OD (avg) | 0.80 | 0.83 | 0.78 | 0.74 | 0.77 | 0.78 | 0.86 | 0.77 | 0.89 |
| C, M, Y Grain (% R) | 2.7 | 1.00 | 0.98 | 0.97 | 0.94 | 0.95 | 0.88 | 0.83 | 0.93 |
| C, M, Y Mottle (% R) | 1.3 | 1.62 | 1.53 | 1.50 | 1.56 | 1.61 | 1.57 | 1.32 | 1.64 |
| Wick (μm) | 83 | 1.15 | 1.10 | 1.07 | 1.09 | 1.11 | 1.10 | 0.97 | 1.15 |
| Wick Blur (%) | 49% | 1.6 | 1.9 | 1.9 | 1.8 | 1.7 | 1.7 | 2.4 | 1.4 |
| Wick Line Rag (μm) | 10.9 | 0.7 | 0.8 | 0.9 | 0.8 | 0.8 | 0.8 | 1.2 | 0.7 |
| Pos Live Dev (μm) | 68 | | | | | | | | |
| Neg Line Dev (μm) | 97 | 33 | 30 | 31 | 45 | 60 | 80 | 73 | 39 |
| | | 30% | 32% | 29% | 35% | 37% | 42% | 43% | 39% |
| Bleed (μm) | 88 | 4.5 | 4.7 | 4.7 | 5.7 | 7.7 | 9.3 | 8.9 | 8.6 |
| Bleed Blur (%) | 50% | 25 | 20 | 23 | 33 | 53 | 67 | 62 | 71 |
| Bleed Rag (μm) | 14.7 | 41 | 39 | 40 | 56 | 67 | 92 | 83 | 84 |
| Line Width Deviation | 100 | 44 | 49 | 58 | 66 | 70 | 80 | 77 | 40 |
| (μm) | | | | | | | | | |
| Waterfastness (% Loss) | 6% | 32% | 35% | 35% | 37% | 41% | 45% | 45% | 41% |
| Drytime (mm) | 0 | 6.7 | 7.2 | 8.1 | 9.2 | 10.8 | 12.6 | 12.5 | 11.5 |

### EXAMPLE 12

### Application of the Compositions of Example 3 to a Standard Office Paper (Staples 24# Printing Paper) Using a Pigment:Binder Ratio of 10

The coating compositions of Example 3, containing VP Disp WK 7330, CELVOL® 523 and glyoxyl at various ratios of glyoxyl to polyvinyl alcohol were applied to Staples 24# printing paper at a coat weight of approximately 1.0 g/m². The coating compositions, properties and process used to coat the paper are summarized in Table 19.

TABLE 19

| | Controls | | | | |
|---|---|---|---|---|---|
| | Base | Glyoxyl (parts per 100 Celvol 523) | | | |
| | Paper | 0 | 5 | 10 | 15 |
| COATING (Dry Parts) | | | | | |
| Celvol 523 | n/a | 100 | 100 | 100 | 100 |
| VP Disp WK 7330 | n/a | n/a | n/a | n/a | n/a |
| Glyoxyl | n/a | 0 | 5 | 10 | 15 |
| COATING | | | | | |
| PROPERTIES | | | | | |
| Pigment - Binder Ratio | n/a | 10.0 | 10.0 | 10.0 | 10.0 |
| Coating Solids (%) | n/a | ~5% | ~5% | ~5% | ~5% |
| COATING PROCESS | | | | | |
| Rod # used | n/a | 3 | 3 | 3 | 3 |
| Coat weight (g/m²) | n/a | 1.05 | 1.09 | 0.9 | 0.94 |

Ink (black, cyan, magenta and yellow) commercially available from Epson or Hewlett Packard was ink jet printed onto the papers coated according to Table 19 using an Epson Stylus Photo R200 printer under the Photo Quality setting, or a Hewlett-Packard Photosmart 8250 printer under the Photo Quality setting. Print quality properties of images were analyzed and are summarized in Tables 20 and 21.

TABLE 20

| | Control | | | | |
|---|---|---|---|---|---|
| PRINT QUALITY | Base | Coat Weight (g/m²) | | | |
| USING EPSON R200 | Paper | 0.65 | 0.90 | 1.49 | 1.93 |
| Color Gamut Area | 5560 | 7093 | 6719 | 7570 | 6524 |
| Black OD | 1.22 | 1.32 | 1.31 | 1.55 | 1.39 |
| Black Grain (% R) | 1.0 | 1.3 | 0.8 | 1.6 | 1.9 |
| Black Mottle (% R) | 0.4 | 0.5 | 0.4 | 0.6 | 1.0 |
| C, M, Y OD (avg) | 0.80 | 0.82 | 0.82 | 0.83 | 0.78 |
| C, M, Y Grain (% R) | 2.5 | 4.3 | 4.5 | 4.5 | 5.1 |
| C, M, Y Mottle (% R) | 1.3 | 1.8 | 1.9 | 2.3 | 3.1 |
| Wick (μm) | 72 | 68 | 76 | 87 | 103 |
| Wick Blur (%) | 42% | 31% | 39% | 42% | 48% |
| Wick Line Rag (μm) | 9.2 | 11.5 | 14.5 | 19.0 | 22.8 |
| Pos Live Dev (μm) | 57 | 65 | 75 | 95 | 121 |
| Neg Line Dev (μm) | 86 | 72 | 78 | 78 | 85 |
| Bleed (μm) | 79 | 60 | 59 | 83 | 111 |
| Bleed Blur (%) | 43% | 35% | 37% | 43% | 44% |
| Bleed Rag (μm) | 11.2 | 15.5 | 21.2 | 29.0 | 40.0 |
| Line Width Deviation | 86 | 79 | 94 | 110 | 157 |
| (μm) | | | | | |
| Waterfastness (% Loss) | 6% | 23% | 22% | 26% | 12% |
| Drytime (mm) | 0 | 0 | 0 | 50 | 38 |

TABLE 21

| PRINT QUALITY | Control | Coat Weight (g/m²) | | | |
|---|---|---|---|---|---|
| USING HP 8250 | Base Paper | 0.65 | 0.90 | 1.49 | 1.93 |
| Color Gamut Area | 6042 | 7721 | 7695 | 7897 | 7665 |
| Black OD | 1.15 | 1.23 | 1.35 | 1.35 | 1.27 |
| Black Grain (% R) | 1.2 | 2.0 | 2.0 | 1.9 | 2.1 |
| Black Mottle (% R) | 0.5 | 0.9 | 0.8 | 0.8 | 1.1 |
| C, M, Y OD (avg) | 1.25 | 1.34 | 1.38 | 1.37 | 1.30 |
| C, M, Y Grain | 1.7 | 2.1 | 2.0 | 2.0 | 2.4 |
| (% R) | | | | | |
| C, M, Y Mottle | 0.7 | 0.7 | 0.7 | 0.8 | 1.0 |
| (% R) | | | | | |
| Wick (μm) | 69 | 56 | 59 | 67 | 77 |
| Wick Blur (%) | 37% | 32% | 33% | 33% | 34% |
| Wick Line Rag (μm) | 7.6 | 8.9 | 7.7 | 9.8 | 14.4 |
| Pos Live Dev (μm) | 51 | 59 | 64 | 77 | 91 |
| Neg Line Dev (μm) | 87 | 53 | 54 | 58 | 62 |
| Bleed (μm) | 55 | 45 | 41 | 46 | 50 |
| Bleed Blur (%) | 37% | 30% | 30% | 32% | 37% |
| Bleed Rag (μm) | 10.6 | 14.8 | 12.7 | 17.5 | 24.8 |
| Line Width | 66 | 72 | 69 | 80 | 103 |
| Deviation (μm) | | | | | |
| Waterfastness | 22% | 36% | 38% | 42% | 28% |
| (% Loss) | | | | | |
| Drytime (mm) | 0 | 1 | 9 | 41 | 9 |

### EXAMPLE 13

### Application of the Compositions of Example 3 to a Standard Office Paper (Staples 24# Printing Paper) Using Various Pigment:Binder Ratios

The coating compositions of Example 3, containing VP Disp WK 7330, CELVOL® 523 and glyoxyl at various ratios of glyoxyl to polyvinyl alcohol were applied to Staples 24# printing paper at a coat weights of approximately 4.0, 5.0, 6.7 and 10.0 g/m². The coating compositions, properties and process used to coat the paper are summarized in Table 22.

TABLE 22

| | Coat Weight Series (g/m²) | | | | |
|---|---|---|---|---|---|
| | Controls | 10 | 6.67 | 5 | 4 |
| COATING (Dry Parts) | | | | | |
| Celvol 523 (PVOH) | n/a | 10 | 15 | 20 | 25 |
| VP Disp WK 7330 | n/a | 100 | 100 | 100 | 100 |
| Glyoxal (crosslinker) | n/a | 1.50 | 2.25 | 3.00 | 3.75 |
| COATING PROP | | | | | |
| Coating Solids (%) | n/a | ~4% | ~4% | ~4% | ~4% |
| COATING PROCESS | | | | | |
| Rod # | n/a | 3 | 3 | 3 | 3 |
| Coat Weight (g/m²) | 0 | 1.21 | 0.99 | 0.9 | 0.94 |

Ink (black, cyan, magenta and yellow) was ink jet printed onto the papers coated according to Table 20 using an Epson Stylus Photo R200 printer under the Photo Quality setting, or a Hewlett-Packard Photosmart 8250 printer under the Photo Quality setting. Print quality properties of images were analyzed and are summarized in Tables 23 and 24.

TABLE 23

| | Control | | | | |
|---|---|---|---|---|---|
| PRINT QUALITY | Base | Coat Weight (g/m²) | | | |
| USING EPSON R200 | Paper | 10 | 6.67 | 10 | 6.67 |
| Color Gamut Area | 5560 | 6575 | 6943 | 7060 | 6901 |
| Black OD | 1.22 | 1.36 | 1.32 | 1.38 | 1.39 |
| Black Grain (% R) | 1.0 | 0.7 | 0.6 | 0.6 | 0.6 |
| Black Mottle (% R) | 0.4 | 0.4 | 0.4 | 0.3 | 0.3 |
| C, M, Y OD (avg) | 0.80 | 0.89 | 0.91 | 0.93 | 0.90 |
| C, M, Y Grain (% R) | 2.5 | 2.3 | 2.2 | 2.1 | 2.3 |
| C, M, Y Mottle (% R) | 1.3 | 1.1 | 1.2 | 1.0 | 1.2 |
| Wick (μm) | 72 | 102 | 96 | 97 | 88 |
| Wick Blur (%) | 42% | 41% | 38% | 40% | 36% |
| Wick Line Rag (μm) | 9.2 | 10.9 | 11.5 | 11.0 | 9.5 |
| Pos Live Dev (μm) | 57 | 104 | 98 | 93 | 77 |
| Neg Line Dev (μm) | 86 | 100 | 95 | 102 | 99 |
| Bleed (μm) | 79 | 94 | 89 | 90 | 86 |
| Bleed Blur (%) | 43% | 42% | 40% | 42% | 39% |
| Bleed Rag (μm) | 11.2 | 14.9 | 13.8 | 14.5 | 13.5 |
| Line Width Deviation | 86 | 112 | 107 | 111 | 102 |
| (μm) | | | | | |
| Waterfastness (% Loss) | 6% | 4% | 0% | 6% | 15% |
| Drytime (mm) | 0 | 0 | 0 | 0 | 0 |

TABLE 24

| | Control | | | | |
|---|---|---|---|---|---|
| PRINT QUALITY | Base | Coat Weight (g/m²) | | | |
| USING HP 8250 | Paper | 10 | 6.67 | 10 | 6.67 |
| Color Gamut Area | 6042 | 6545 | 6731 | 6594 | 6624 |
| Black OD | 1.15 | 1.23 | 1.28 | 1.25 | 1.29 |
| Black Grain (% R) | 1.2 | 1.0 | 0.9 | 1.0 | 0.7 |
| Black Mottle (% R) | 0.5 | 0.5 | 0.5 | 0.5 | 0.3 |
| C, M, Y OD (avg) | 1.25 | 1.37 | 1.40 | 1.36 | 1.46 |
| C, M, Y Grain (% R) | 1.7 | 1.4 | 1.3 | 1.3 | 1.0 |
| C, M, Y Mottle (% R) | 0.7 | 0.6 | 0.6 | 0.5 | 0.4 |
| Wick (μm) | 69 | 94 | 91 | 91 | 82 |
| Wick Blur (%) | 37% | 36% | 34% | 35% | 30% |
| Wick Line Rag (μm) | 7.6 | 10.2 | 11.0 | 9.9 | 9.0 |
| Pos Live Dev (μm) | 51 | 101 | 100 | 99 | 91 |
| Neg Line Dev (μm) | 87 | 87 | 83 | 84 | 74 |
| Bleed (μm) | 55 | 50 | 49 | 49 | 55 |
| Bleed Blur (%) | 37% | 35% | 34% | 35% | 34% |
| BleedRag (μm) | 10.6 | 12.5 | 12.5 | 13.5 | 11.2 |
| Line Width Deviation | 66 | 86 | 86 | 86 | 90 |
| (μm) | | | | | |
| Waterfastness (% Loss) | 22% | 13% | 14% | 12% | 23% |
| Drytime (mm) | 0 | 0 | 0 | 0 | 0 |

### EXAMPLE 14

### Compositions Comprising an Acidic Fumed Silica Dispersion, a Binder, a PolyDADMAC and a Foam Control Agent

A composition was made by combining CELVOL® 523 (polyvinyl alcohol) with water using a DISPERMAT® mixer with a high shear blade at a shear rate of 1200 inverse minutes, or by vigorous shaking. Glyoxal (Cartabond TSI from Clariant Corp.) was added at 2.5 parts dry weight per 100 parts polyvinyl alcohol to reduce the water solubility of polyvinyl alcohol. The composition was mixed using a DISPERMAT® mixer with a high shear blade at a shear rate of 1200 inverse minutes, or by vigorous shaking. A portion of the resulting composition was combined with VP Disp WK 7330 (a slightly acidic, cationic, water-based dispersion of fumed mixed metal oxide) and the cationic polymer Induquat 35L (polyDADMAC) at 30 parts Induquat 35L per 100 parts dry weight VP Disp WK 7330 using a DISPERMAT® mixer with a high shear blade at a shear rate of 1200 inverse minutes, or by vigorous shaking. The proportions of AERODISP® and CELVOL® 523 were chosen such that the weight ratio of fumed silica to polyvinyl alcohol in the composition was 10:1.

A second composition was made by combining VP Disp WK 7330 with CELVOL® 523 using a DISPERMAT® mixer with a high shear blade at a shear rate of 1200 inverse minutes, or by vigorous shaking. The coat weight (g/m²) ratio of fumed silica to polyvinyl alcohol in the composition was 10:1. A portion of the resulting dispersion was combined with the cationic polymer CATIOFAST CS (a polyDADMAC) using a DISPERMAT® mixer with a high shear blade at a shear rate of 1200 inverse minutes, or by vigorously shaking. The proportion of CATIOFAST CS to VP Disp WK 7330 dispersion was 1 part per 100 parts dry weight. The dye fixative CARTAFIX® 4440, commercially available from Clariant Corporation, UK, was combined with the resulting dispersion at 30 parts CARTAFIX® 4440 per 100 parts dry weight.

A third composition was made by combining AKZO NOBEL IJ 935 colloidal silica dispersion with CELVOL® 523 using a DISPERMAT® mixer with a high shear blade at a shear rate of 1200 inverse minutes, or by vigorous shaking. The coat weight (g/m²) ratio of fumed silica to polyvinyl alcohol in the composition was 10:1. A portion of the resulting dispersion was combined with the cationic polymer CATIOFAST CS (a polyDADMAC) using a DISPERMAT® mixer with a high shear blade at a shear rate of 1200 inverse minutes, or by vigorously shaking. The proportion of CATIOFAST CS to AKZO NOBEL IJ 935 dispersion was 1 part per 100 parts dry weight. Induquat 35L, was combined with the resulting dispersion at 30 parts Induquat 35L per 100 parts dry weight.

### EXAMPLE 15

### Application of the Compositions of Example 14 to a Standard Office Paper (Staples 24# Printing Paper)

Each of the three coating compositions of Example 14 were applied to Staples 24# printing paper at the coat weights indicated in Tables 23 and 24.

Ink (black, cyan, magenta and yellow) was ink jet printed onto the papers using an Epson Stylus Photo R200 printer under the Photo Quality setting, or a Hewlett-Packard Photosmart 8250 printer under the Photo Quality setting. Print quality properties of images were analyzed and are summarized in Tables 25 and 26.

TABLE 25

| | Control | | | |
|---|---|---|---|---|
| | Base Paper | WK 7330 | WK 7330 | IJ 935 |
| | Silica Dispersion Coat | 1.2 | 0.42 | 0.83 |
| PRINT QUALITY | weight (g/m²) | Induquat | Catiofast | Catiofast |
| USING EPSON R200 | Other components | Glyoxyl | Cartafix | Induquat |
| Color Gamut Area | 5560 | 7945 | 7269 | 6453 |
| K, C, M, Y OD (avg) | | 1.05 | 1.09 | 0.97 |
| K, C, M, Y Grain (avg % R) | | 2.0 | 1.7 | 2.0 |
| K, C, M, Y Mottle (avg % R) | | 1.0 | 0.8 | 0.9 |
| Wick (μm) | 72 | 75 | 67 | 79 |
| Wick Blur (%) | 42% | 34% | 34% | 42% |
| Wick Line Rag (μm) | 9.2 | 8.2 | 8.8 | 11.1 |
| Bleed (μm) | 79 | 36 | 74 | 74 |
| Bleed Blur (%) | 43% | 34% | 36% | 42% |
| Bleed Rag (μm) | 11.2 | 11.8 | 12.7 | 13.6 |
| Waterfastness (% Loss) | 6% | 0% | 8% | 2% |
| Drytime (mm) | 0 | 0 | 0 | 0 |

TABLE 26

| | Control | | | |
|---|---|---|---|---|
| | Base Paper | WK 7330 | WK 7330 | IJ 935 |
| | Silica Dispersion Coat | 1.2 | 0.42 | 0.83 |
| PRINT QUALITY | weight (g/m²) | Induquat | Catiofast | Catiofast |
| USING USING HP 8250 | Other components | Glyoxyl | Cartafix | Induquat |
| Color Gamut Area | 5560 | 7391 | 6933 | 6097 |
| K, C, M, Y OD (avg) | | 1.18 | 1.36 | 1.26 |
| K, C, M, Y Grain (avg % R) | | 1.7 | 1.3 | 1.8 |
| K, C, M, Y Mottle (avg % R) | | 0.7 | 0.6 | 0.8 |
| Wick (μm) | 72 | 68 | 67 | 75 |
| Wick Blur (%) | 42% | 32% | 31% | 37% |
| Wick Line Rag (μm) | 9.2 | 9.2 | 8.1 | 9.8 |
| Bleed (μm) | 79 | 44 | 45 | 42 |
| Bleed Blur (%) | 43% | 33% | 31% | 33% |
| Bleed Rag (μm) | 11.2 | 9.8 | 11.1 | 12.8 |
| Waterfastness (% Loss) | 6% | 0% | 12% | 6% |
| Drytime (mm) | 0 | 0 | 0 | 0 |

### EXAMPLE 16

### Measurement of the Specular Gloss of Coated Papers

The specular gloss of Staples 24# printing paper was measured using a gloss meter (micro-TRI-gloss meter, commercially available from BYK-Gardener USA) before and after being coated with compositions of Example 1, applied to the paper according to Example 4. The uncoated paper had a specular gloss of 4.1 at 60° and 4.5 at 85°. Paper coated with W7520 at a pigment to binder ration of 2.5 and a coat weight of 3.9 g/m² had a specular gloss of 3.7 at 60° and 11.9 at 85°. Paper coated with W7520 at a pigment to binder ration of 10 and a coat weight of 3.6 g/m² had a specular gloss of 3.1 at 60° and 7.5 at 85°.

All patents, publications and references cited herein are hereby fully incorporated by reference. In case of conflict between the present disclosure and incorporated patents, publications and references, the present disclosure should control.

What is claimed:

1. A coated substrate comprising a substrate coated with a coating at a coat weight of less than about 0.8 g coating/m² substrate, the coating comprising a metal oxide.

2. The coated substrate of claim 1, wherein the coated substrate has a specular gloss of less than about 15% at 60°.

3. The coated substrate of claim 1, wherein the metal oxide comprises fumed silica, and the coating further comprises polyvinyl alcohol, poly(diallyl dimethyl ammonium chloride) and glyoxyl.

4. The coated substrate of claim 1, wherein the substrate comprises a paper.

5. The coated substrate of claim 4, wherein the substrate comprises a commodity paper.

6. The coated substrate of claim 1, wherein the metal oxide comprises a fumed metal oxide.

7. The coated substrate of claim 1, wherein the metal oxide comprises at least one of fumed silica, colloidal silica, fumed alumina and combinations thereof.

8. The coated substrate of claim 1, wherein the metal oxide is doped with a different metal oxide.

9. The coated substrate of claim 8, wherein the metal oxide comprises alumina doped silica.

10. The coated substrate of claim 1, wherein the coat weight is from about 0.05 g coating/m² substrate to about 0.5 g coating/m² substrate.

11. The coated substrate of claim 1, wherein the coat weight is less than about 0.2 g coating/m² substrate.

12. The coated substrate of claim 1, wherein the coating provides less than about 0.5 g metal oxide/m² substrate.

13. A recording medium comprising the coated substrate of claim 1 and further comprising an image printed onto the coated substrate, wherein the image shows an improved color gamut of at least about 5% compared to the same image printed on the same substrate without the coating.

14. The recording medium of claim 13, wherein the coated substrate has a specular gloss of less than about 15% at 60°.

15. A recording medium comprising the coated substrate of claim 1 and further comprising an image printed onto the coated substrate, wherein the image shows an improved trait selected from an improved wick of at least about 5%; an improved bleed of at least about 5%; an improved optical density of at least about 5%; and combinations thereof, when compared to the same image printed on the same substrate without the coating.

16. A coated substrate comprising a substrate coated with a coating comprising a metal oxide, the coated substrate having a specular gloss of less than about 15% at 60°.

17. The coated substrate of claim 16, wherein the coat weight is less than about 5 g coating/m² substrate.

18. The coated substrate of claim 16, wherein the coat weight is less than about 0.2 g coating/m² substrate.

19. The coated substrate of claim 16, wherein the metal oxide comprises fumed silica, and the coating further comprises polyvinyl alcohol, poly(diallyl dimethyl ammonium chloride) and glyoxyl.

20. The coated substrate of claim 16, wherein the coating provides less than about 4 g metal oxide/m² substrate.

21. The coated substrate of claim 20, wherein the coating provides less than about 0.5 g metal oxide/m² substrate.

22. A recording medium comprising the coated substrate of claim 16 and further comprising an image printed onto the coated substrate, wherein the image shows an improved color gamut of at least about 5% compared to the same image printed on the same substrate without the coating.

23. The recording medium of claim 22, wherein the coated substrate has a coat weight of less than about 0.8 g coating/m² substrate.

24. A recording medium comprising the coated substrate of claim 16 and further comprising an image printed onto the coated substrate, wherein the image shows an improved trait selected from an improved wick of at least about 5%; an improved bleed of at least about 5%; an improved optical density of at least about 5%; and combinations thereof, when compared to the same image printed on the same substrate without the coating.

25. A method of making a coated paper comprising:
(a) using a size press to apply a coating comprising a metal oxide to a paper at a coat weight of less than about 5 g coating/m² paper; and
(b) producing a coated paper having a specular gloss of less than about 15% at 60°.

26. The method of claim 25, further comprising calendaring the paper after application of the coating.

27. The method of claim 25, wherein the size press is in-line with a paper making machine.

28. The method of claim 25, wherein the metal oxide comprises fumed silica, and the coating further comprises polyvinyl alcohol, poly(diallyl dimethyl ammonium chloride) and glyoxyl.

29. The method of claim 25, wherein the metal oxide is selected from fumed silica, colloidal silica, fumed alumina and combinations thereof.

30. The method of claim 25, wherein the coat weight is from about 0.05 g coating/m² substrate to about 0.5 g coating/m² substrate.

31. The method of claim 25, wherein the coat weight is less than about 0.2 g coating/m² substrate.

32. The method of claim 25, wherein the coating provides less than about 0.5 g metal oxide/m² substrate.
